(19) United States
(12) Patent Application Publication
(10) Pub. No.: US 2013/0035034 A1
(43) Pub. Date: Feb. 7, 2013

(54) COMMUNICATION APPARATUS AND COMMUNICATION METHOD IN WIRELESS POWER TRANSMISSION SYSTEM

(71) Applicants: Nam Yun Kim, Seoul (KR); Sang Wook Kwon, Seongnam-si (KR); Eun Seok Park, Yongin-si (KR)

(72) Inventors: Nam Yun Kim, Seoul (KR); Sang Wook Kwon, Seongnam-si (KR); Eun Seok Park, Yongin-si (KR)

(73) Assignee: Samsung Electronics Co., Ltd., Suwon-si (KR)

(21) Appl. No.: 13/567,864

(22) Filed: Aug. 6, 2012

(30) Foreign Application Priority Data
Aug. 5, 2011 (KR) 10-2011-0078010

(51) Int. Cl. H04B 5/00; H02J 17/00

(52) U.S. Cl. 455/41.1

(57) ABSTRACT

A communication method in a wireless power transmission system includes detecting state information of a plurality of channels available in a communication cell when all of the plurality of channels have already been respectively assigned to a plurality of sources configured to transmit wireless power respectively, determining a channel to be used for communication based on the state information, determining whether the determined channel is being used by a respective one of the plurality of sources to which the determined channel has already been assigned, and determining whether the determined channel is to be used for communication based on a result of the determination of whether the determined channel is being used.

### CROSS-REFERENCE TO RELATED APPLICATIONS

This application claims the benefit under 35 USC 119(a) of Korean Patent Application No. 10-2011-0078010 filed on Aug. 5, 2011, in the Korean Intellectual Property Office, the entire disclosure of which is incorporated herein by reference for all purposes.

### BACKGROUND

1. Field

The following description relates to an apparatus and a method for performing communication in a wireless power transmission system.

2. Description of Related Art

Research on wireless power transmission has been conducted to overcome the inconvenience of wired power supplies, or the limited capacity of conventional batteries, due to a rapid increase in various electronic devices including electric vehicles, mobile devices, and other devices that are intended to be used without being connected to a wired power supply. One type of wireless power transmission technology uses resonance characteristics of radio frequency (RF) devices. For example, a wireless power transmission system using resonance characteristics includes a source configured to supply power, and a target configured to receive the power supplied by the source.

### SUMMARY

In one general aspect, a communication apparatus in a wireless power transmission system includes a state information detector configured to detect state information of a plurality of channels available in a communication cell when all of the plurality of channels have already been respectively assigned to a plurality of sources configured to transmit wireless power; and a controller configured to determine one of the plurality of channels to be used for communication by the communication apparatus based on the state information, determine whether the determined channel is being used by a respective one of the plurality of sources to which the determined channel has already been assigned, and determine whether the determined channel is to be used by the communication apparatus depending on a result of the determination of whether the determined channel is being used.

The state information detector may be further configured to detect, as the state information of the plurality of channels, a received signal strength indicator (RSSI) of each of the plurality of channels, a Link Quality Indicator (LQI) of each of the plurality of channels, and whether each of the plurality of channels is being used by a respective one of the plurality of sources to which the plurality of channels have already been respectively assigned.

The state information detector may be further configured to detect whether each of the plurality of channels is being used by the plurality of sources to which the plurality of channels have already been respectively assigned by detecting whether the communication apparatus receives a respective continuous wave signal from each of the plurality of sources.

The controller may be further configured to determine another one of the plurality of channels to be used by the communication apparatus based on state information of remaining ones of the plurality of channels excluding the determined channel when the determined channel is being used by the respective one of the plurality of sources to which the determined channel has already been assigned.

The communication apparatus may further include a transmitting unit configured to transmit control information to a target in a power cell of the communication apparatus that is configured to receive wireless power from the communication apparatus via the determined channel when the determined channel is not being used by the respective one of the plurality of sources to which the determined channel has already been assigned.

The communication apparatus of claim 5 may further include a receiving unit configured to receive, from any of the plurality of sources or any new source that may enter the communication cell, a channel assignment request message to request assignment of the determined channel while the communication apparatus is operating in a receiving mode.

The transmitting unit may be further configured to perform communication with the target via the determined channel; and the state information detector may be further configured to detect a number of sources attempting to use the determined channel and a channel frequency of the determined channel during a predetermined time period after the communication with the target has been completed.

The predetermined time period may be determined based on a minimum amount of time required for a source to perform communication with a target.

The controller may be further configured to determine whether the determined channel is to be changed based on the detected number of sources attempting to use the determined channel during the predetermined time period and the detected channel frequency.

The transmitting unit may be further configured to transmit information indicating that the determined channel is to be changed and information about a channel to be changed to the target via the determined channel when the controller determines that the determined channel is to be changed.

In another general aspect, a communication apparatus in a wireless power transmission system includes an operating mode converter configured to switch an operating mode of the communication apparatus to a transmitting mode or a receiving mode based on a communication operation to be performed by the communication apparatus when all of a plurality of channels available in a communication cell have already been respectively assigned to a plurality of sources configured to transmit wireless power, the communication apparatus being one of the plurality of sources; and a controller configured to control the communication apparatus to operate in a standby mode to wait to perform a future communication operation without using the respective one of the plurality of channels that has been assigned to the communication apparatus while operating in the standby mode when the communication to be performed by the communication apparatus has been completed.

The communication apparatus may further include a transmitting unit configured to transmit state information of the respective one of the plurality of channels that has been assigned to the communication apparatus using a continuous wave signal when the communication apparatus is performing a communication operation in the transmitting mode.

The state information may include information about the communication apparatus, information about a target that is configured to receive wireless power from the communication apparatus, and information about a schedule for the communication apparatus.

The communication apparatus may further include a receiving unit configured to receive a channel assignment request message to request assignment of the determined channel from any of the plurality of sources excluding the communication apparatus and any new source that may enter the communication cell.

In another general aspect, a communication method in a wireless power transmission system includes detecting state information of a plurality of channels available in a communication cell when all of the plurality of channels have already been respectively assigned to a plurality of sources configured to transmit wireless power; determining a channel to be used for communication based on the state information; determining whether the determined channel is being used by a respective one of the plurality of sources to which the determined channel has already been assigned; and determining whether the determined channel is to be used for communication depending on a result of the determining of whether the determined channel is being used.

The detecting of the state information may includes detecting, as the state information, a received signal strength indicator (RSSI) of each of the plurality of channels, a Link Quality Indicator (LQI) of each of the plurality of channels, and whether each of the plurality of channels is being used by a respective one of the plurality of sources to which the plurality of channels have already been respectively assigned.

The communication method may further include determining another one of the plurality of channels to be used to perform communication based on state information of remaining ones of the plurality of channels excluding the determined channel when the determined channel is being used by the respective one of the plurality of sources to which the determined channel has already been assigned.

The communication method may further include transmitting control information to a target in a power cell that is configured to receive wireless power via the determined channel when the determined channel is not being used by the respective one of the plurality of sources to which the determined channel has already been assigned.

The communication method may further include performing communication with the target via the determined channel; and detecting a number of sources attempting to use the determined channel and a channel frequency of the determined channel during a predetermined time period after the communication with the target has been completed.

Other features and aspects will be apparent from the following detailed description, the drawings, and the claims.

### BRIEF DESCRIPTION OF THE DRAWINGS

FIG. 1 is a diagram illustrating an example of a wireless power transmission and charging system.

FIGS. 2A and 2B are diagrams illustrating an example of a process of assigning a channel to a source in a wireless power transmission system.

FIG. 3 is a diagram illustrating an example of a communication apparatus in a wireless power transmission system.

FIG. 4 is a diagram illustrating another example of a communication apparatus in a wireless power transmission system.

FIG. 5 is a diagram illustrating an example of a process of assigning a channel to an additional source entering a communication cell in a wireless power transmission system.

FIG. 6 is a diagram illustrating an example of a process of detecting a channel frequency and a number of sources attempting to use a channel during a predetermined time period performed by a communication apparatus in a wireless power transmission system.

FIG. 7 is a diagram illustrating an example of a process of informing a target of a channel change and transmitting data to the target performed by a source that that has determined to change a channel in a wireless power transmission system.

FIG. 8 is a flowchart illustrating an example of a communication method in a wireless power transmission system.

FIG. 9 is a diagram illustrating another example of a communication apparatus in a wireless power transmission system.

FIGS. 10A through 10B are diagrams illustrating examples of a distribution of a magnetic field in a feeder and a resonator of a wireless power transmitter.

FIGS. 11A and 11B are diagrams illustrating an example of a wireless power transmitter including a resonator and a feeding unit.

FIG. 12A is a diagram illustrating an example of a distribution of a magnetic field inside a resonator produced by feeding of a feeding unit.

FIG. 12B is a diagram illustrating examples of equivalent circuits of a feeding unit and a resonator.

FIG. 13 is a diagram illustrating an example of an electric vehicle charging system.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and the sequences of operations are not limited to those set forth herein, but may be changed as will be apparent to one of ordinary skill in the art, with the exception of operations necessarily occurring in a certain order. Also, description of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

A scheme of performing communication between a source device and a target device may include an in-band communication scheme, or an out-of-band communication scheme, or both. The in-band communication scheme refers to communication performed between the source device and the target device in the same frequency band that is used for power transmission. The out-of-band communication scheme refers to communication performed between the source device and the target device in a different frequency band than a frequency band used for power transmission.

When a plurality of source devices are densely positioned, communication between the source device and the target device may be difficult due to communication errors and signal interference from other devices. A communication apparatus in a wireless power transmission system may determine an optimal channel without interference by obtaining information about a channel that is currently not being used by other source devices in a process of assigning, to a source device, a channel to be used to perform communication.

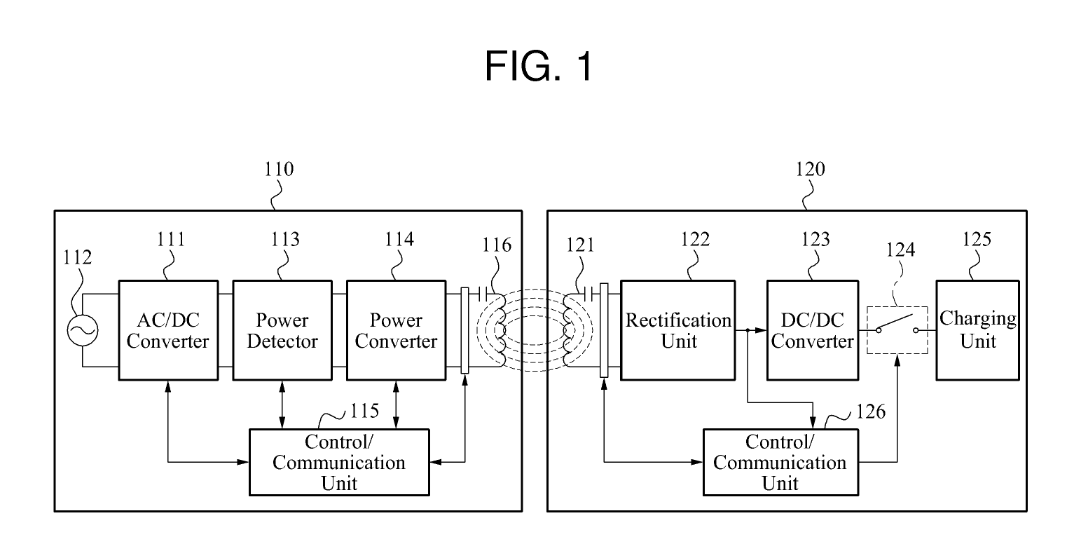

FIG. 1 is a diagram illustrating an example of a wireless power transmission and charging system. Referring to FIG. 1, the wireless power transmission and charging system includes a source device 110 and a target device 120. The source device 110 is a device supplying wireless power, and may be any of various devices that supply power, such as pads, terminals, televisions (TVs), and any other device that supplies power. The target device 120 is a device receiving wireless power, and may be any of various devices that consume power, such as terminals, TVs, vehicles, washing machines, radios, lighting systems, and any other device that consumes power.

The source device 110 includes an alternating current-to-direct current (AC/DC) converter 111, a power detector 113, a power converter 114, a control and communication (control/communication) unit 115, and a source resonator 116.

The target device 120 includes a target resonator 121, a rectification unit 122, a DC-to-DC (DC/DC) converter 123, a switch unit 124, a charging unit 125, and a control/communication unit 126.

The AC/DC converter 111 generates a DC voltage by rectifying an AC voltage having a frequency of tens of hertz (Hz) output from a power supply 112. The AC/DC converter 111 may output a DC voltage having a predetermined level, or may output a DC voltage having an adjustable level that is controlled by the control/communication unit 115.

The power detector 113 detects an output current and an output voltage of the AC/DC converter 111, and provides, to the control/communication unit 115, information on the detected current and the detected voltage. Additionally, the power detector 113 detects an input current and an input voltage of the power converter 114.

The power converter 114 generates power by converting the DC voltage output from the AC/DC converter 111 to an AC voltage using a switching pulse signal having a frequency of a few kilohertz (kHz) to tens of megahertz (MHz). In other words, the power converter 114 converts a DC voltage supplied to a power amplifier to an AC voltage using a reference resonant frequency F_{Ref}, and generates a communication power to be used for communication, or a charging power to be used for charging that may be used in a plurality of target devices. The communication power may be, for example, a low power of 0.1 to 1 milliwatts (mW) that may be used by a target device to perform communication, and the charging power may be, for example, a high power of 1 mW to 200 Watts (W) that may be consumed by a device load of a target device. In this description, the term “charging” may refer to supplying power to an element or a unit that charges a battery or other rechargeable device with power. Also, the term “charging” may refer to supplying power to an element or a unit that consumes power. For example, the term “charging power” may refer to power consumed by a target device while operating, or power used to charge a battery of the target device. The unit or the element may include, for example, a battery, a display device, a sound output circuit, a main processor, and various types of sensors.

In this description, the term “reference resonant frequency” refers to a resonant frequency that is nominally used by the source device 110, and the term “tracking frequency” refers to a resonant frequency used by the source device 110 that has been adjusted based on a predetermined scheme.

The control/communication unit 115 may detect a reflected wave of the communication power or a reflected wave of the charging power, and may detect mismatching between the target resonator 121 and the source resonator 116 based on the detected reflected wave. The control/communication unit 115 may detect the mismatching by detecting an envelope of the reflected wave, or by detecting an amount of a power of the reflected wave. The control/communication unit 115 may calculate a voltage standing wave ratio (VSWR) based on a voltage level of the reflected wave and a level of an output voltage of the source resonator 116 or the power converter 114. When the VSWR is greater than a predetermined value, the control/communication unit 115 detects that there is mismatching between the target resonator 121 and the source resonator 116. In this example, the control/communication unit 115 calculates a power transmission efficiency of each of N predetermined tracking frequencies, determines a tracking frequency F_{Best} having the best power transmission efficiency among the N predetermined tracking frequencies, and changes the reference resonant frequency F_{Ref} to the tracking frequency F_{Best}.

Also, the control/communication unit 115 may control a frequency of the switching pulse signal used by the power converter 114. By controlling the switching pulse signal used by the power converter 114, the control/communication unit 115 may generate a modulation signal to be transmitted to the target device 120. In other words, the control/communication unit 115 may transmit various messages to the target device 120 via in-band communication. Additionally, the control/communication unit 115 may detect a reflected wave, and may demodulate a signal received from the target device 120 through an envelope of the reflected wave.

The control/communication unit 115 may generate a modulation signal for in-band communication using various schemes. To generate a modulation signal, the control/communication unit 115 may turn on or off the switching pulse signal used by the power converter 114, or may perform delta-sigma modulation. Additionally, the control/communication unit 115 may generate a pulse-width modulation (PWM) signal having a predetermined envelope.

The control/communication unit 115 may perform out-of-band communication using a communication channel. The control/communication unit 115 may include a communication module, such as a ZigBee module, a Bluetooth module, or any other communication module known to one of ordinary skill in the art, that the control/communication unit 115 may use to perform the out-of-band communication. The control/communication unit 115 may transmit or receive data to or from the target device 120 via the out-of-band communication.

The source resonator 116 transfers electromagnetic energy, such as the communication power or the charging power, to the target resonator 121 via a magnetic coupling with the target resonator 121.

The target resonator 121 receives the electromagnetic energy, such as the communication power or the charging power, from the source resonator 116 via a magnetic coupling with the source resonator 116. Additionally, the target resonator 121 receives various messages from the source device 110 via the in-band communication.

The rectification unit 122 generates a DC voltage by rectifying an AC voltage received by the target resonator 121.

The DC/DC converter 123 adjusts a level of the DC voltage output from the rectification unit 122 based on a voltage rating of the charging unit 125. For example, the DC/DC converter 123 may adjust the level of the DC voltage output from the rectification unit 122 to a level in a range from 3 volts (V) to 10 V.

The switch unit 124 is turned on and off by the control/communication unit 126. When the switch unit 124 is turned off, the control/communication unit 115 of the source device 110 may detect a reflected wave. In other words, when the switch unit 124 is turned off, the magnetic coupling between the source resonator 116 and the target resonator 121 is interrupted.

The charging unit 125 may include a battery. The charging unit 125 may charge the battery using the DC voltage output from the DC/DC converter 123.

The control/communication unit 126 may perform in-band communication for transmitting or receiving data using a resonant frequency by demodulating a received signal obtained by detecting a signal between the target resonator 121 and the rectification unit 122, or by detecting an output signal of the rectification unit 122. In other words, the control/communication unit 126 may demodulate a message received via the in-band communication.

Additionally, the control/communication unit 126 may adjust an impedance of the target resonator 121 to modulate a signal to be transmitted to the source device 110. Specifically, the control/communication unit 126 may modulate the signal to be transmitted to the source device 110 by turning the switch unit 124 on and off. For example, the control/communication unit 126 may increase the impedance of the target resonator 121 by turning the switch unit 124 off so that a reflected wave will be detected by the control/communication unit 115 of the source device 110. In this example, depending on whether the reflected wave is detected, the control/communication unit 115 of the source device 110 will detect a binary number “0” or “1.”

The control/communication unit 126 may transmit, to the source device 110, any one or any combination of a response message including a product type of a corresponding target device, manufacturer information of the corresponding target device, a product model name of the corresponding target device, a battery type of the corresponding target device, a charging scheme of the corresponding target device, an impedance value of a load of the corresponding target device, information about a characteristic of a target resonator of the corresponding target device, information about a frequency band used by the corresponding target device, an amount of power to be used by the corresponding target device, an intrinsic identifier of the corresponding target device, product version information of the corresponding target device, and standards information of the corresponding target device.

The control/communication unit 126 may also perform an out-of-band communication using a communication channel. The control/communication unit 126 may include a communication module, such as a ZigBee module, a Bluetooth module, or any other communication module known to one of ordinary skill in the art, that the control/communication unit 126 may use to transmit or receive data to or from the source device 110 via the out-of-band communication.

The control/communication unit 126 may receive a wake-up request message from the source device 110, detect an amount of a power received by the target resonator 121, and transmit, to the source device 110, information about the amount of the power received by the target resonator 121. In this example, the information about the amount of the power received by the target resonator 121 may correspond to an input voltage value and an input current value of the rectification unit 122, an output voltage value and an output current value of the rectification unit 122, or an output voltage value and an output current value of the DC/DC converter 123.

The control/communication unit 115 may set a resonance bandwidth of the source resonator 116. Based on the set resonance bandwidth of the source resonator 116, a Q-factor Q_{S} of the source resonator 116 may be determined.

The control/communication unit 126 may set a resonance bandwidth of the target resonator 116. Based on the set resonance bandwidth of the target resonator 116, a Q-factor Q_{D} of the target resonator 121 may be determined. In this example, the resonance bandwidth of the source resonator 116 may be set to be wider or narrower than the resonance bandwidth of the target resonator 121. By communicating with each other, the source device 110 and the target device 120 may share information regarding the resonance bandwidths of the source resonator 116 and the target resonator 121. When a power higher than a reference value is requested by the target device 120, the Q-factor Q_{S} of the source resonator 116 may be set to a value greater than 100. When a power lower than the reference value is requested by the target device 120, the Q-factor Q_{S} of the source resonator 116 may be set to a value less than 100.

In resonance-based wireless power transmission, a resonance bandwidth is a significant factor. Let Qt denote a Q-factor of energy coupling between the source resonator 116 and the target resonator 121. The value of Qt is affected by a change in a distance between the source resonator 116 and the target resonator 121, a change in a resonance impedance, impedance-mismatching, a reflected signal, or any other factor affecting a Q-factor. Qt is inversely proportional to a resonance bandwidth as expressed by the following Equation 1:

$$\begin{matrix}\frac{{Δ}_{f}}{{f}_{0}} = \frac{1}{Qt} \\ = {Γ}_{S , D} + \frac{1}{{BW}_{S}} + \frac{1}{{BW}_{D}}\end{matrix} \qquad ( 1 )$$

In Equation 1, f₀ denotes a center frequency, Δf denotes a bandwidth, Γ_{S,D} denotes a reflection loss between resonators, BW_{S} denotes a resonance bandwidth of the source resonator 116, and BW_{D} denotes a resonance bandwidth of the target resonator 121.

An efficiency U of wireless power transmission may be expressed by the following Equation 2:

$$U = \frac{κ}{\sqrt{{Γ}_{S} {Γ}_{D}}} = \frac{{ω}_{0} M}{\sqrt{{R}_{S} {R}_{D}}} = \frac{\sqrt{{Q}_{S} {Q}_{D}}}{{Q}_{κ}} \qquad ( 2 )$$

In Equation 2, κ denotes a coupling coefficient of energy coupling between the source resonator 116 and the target resonator 121, Γ_{S} denotes a reflection coefficient of the source resonator 116, Γ_{D} denotes a reflection coefficient of the target resonator 121, ω₀ denotes a resonant frequency, M denotes a mutual inductance between the source resonator 116 and the target resonator 121, R_{S} denotes an impedance of the source resonator 116, R_{D} denotes an impedance of the target resonator 121, Q_{S} denotes a Q-factor of the source resonator 116, Q_{D} denotes a Q-factor of the target resonator 121, and Q_{κ} denotes a Q-factor of energy coupling between the source resonator 116 and the target resonator 121, and is the same as Qt discussed above in connection with Equation 1.

As can be seen from Equation 2, the Q-factor has a great effect on an efficiency of the wireless power transmission. Accordingly, the Q-factor may be set to a high value to increase the efficiency of the wireless power transmission. However, even when Q_{S} and Q_{D} are set to high values, the efficiency of the wireless power transmission may be reduced by a change in the coupling coefficient κ of the energy coupling, a change in a distance between the source resonator 116 and the target resonator 121, a change in a resonance impedance, impedance mismatching, and any other factor affecting the efficiency of the wireless power transmission.

If the resonance bandwidths BW_{S} and BW_{D} of the source resonator 116 and the target resonator 121 are set to be too narrow to increase the efficiency of the wireless power transmission, impedance mismatching and other undesirable conditions may easily occur due to insignificant external influences. In order to account for the effect of impedance mismatching, Equation 1 may be rewritten as the following Equation 3:

$$\frac{{Δ}_{f}}{{f}_{0}} = \frac{\sqrt{VSWR} - 1}{Qt \sqrt{VSWR}} \qquad ( 3 )$$

In an example in which an unbalanced relationship of a resonance bandwidth or a bandwidth of an impedance matching frequency between the source resonator 116 and the target resonator 121 is maintained, a reduction in an efficiency of the wireless power transmission may be prevented due to a change in the coupling coefficient κ, a change in the distance between the source resonator 116 and the target resonator 121, a change in the resonance impedance, impedance mismatching, and any other factor affecting the efficiency of the wireless power transmission.

According to Equation 1 through Equation 3, when the resonance bandwidth between the source resonator 116 and the target resonator 121 or the bandwidth of an impedance-matching frequency remains unbalanced, the Q-factor of the source resonator 116 and the Q-factor of the target resonator 121 may remain unbalanced.

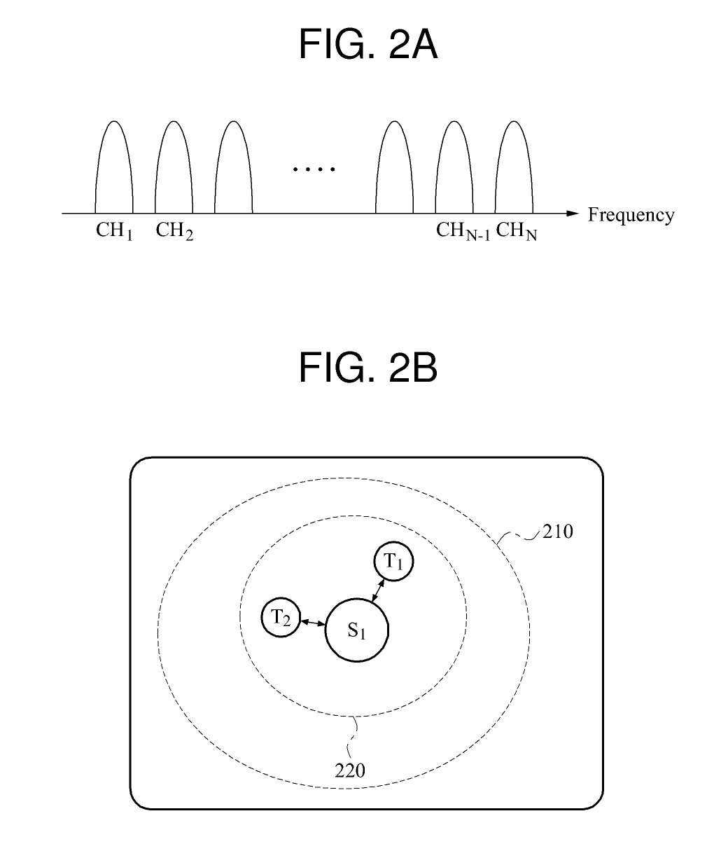

FIGS. 2A and 2B are diagrams illustrating an example of a process of assigning a channel to a source in a wireless power transmission system. In this description, the term “source” refers to a source device, and the term “target” refers to a target device. Referring to FIGS. 2A and 2B, when a plurality of sources (not shown) are positioned in a single communication cell 210 shown in FIG. 2B, a channel available in the communication cell 210 is assigned to each source for the source to use to perform communication. In this example, it will be assumed that N channels CH₁ to CH_{N} as shown in FIG. 2A are available in the communication cell 210.

When a source S₁ enters the communication cell 210, the source S₁ determines states of the N channels, and assigns a channel in a best state among the N channels to the source S₁. In this example, a state of a channel is determined based on a Received Signal Strength Indicator (RSSI) and a Link Quality Indicator (LQI) of the channel. Assuming that a channel CH₁ is in a best state, the source S₁ assigns the channel CH₁ to the source S₁. Then, when a source S₂ (not shown) enters the communication cell 210, the source S₂ assigns a channel CH₂ in a best state among the remaining N−1 channels excluding the channel CH₁ to the source S₂. When a source S_{N} (not shown in FIG. 2B) enters the communication cell 210 after channels CH₁ to CH_{N-1} have been assigned to sources S₁ to S_{N-1} (not shown in FIG. 2B) that sequentially entered the communication cell 210, the source S_{N} assigns a last remaining channel CH_{N} to the source S_{N}. By using this scheme, when N sources enter the communication cell 210, the N sources assign the N channels to the N sources so that a different one of the N channels is assigned to each of the N sources.

The sources to which the channels are assigned perform communication with targets via the assigned channels in respective power cells of the sources. For example, as shown in FIG. 2B, the source S₁ performs communication with targets T₁ and T₂ via the channel CH₁ assigned to the source S₁ in a power cell 220 of the source S₁. The communication cell 210 is an area in which a source can perform communication using an assigned channel, and the power cell 220 is an area in which the source S₁ can transmit wireless power.

However, when an additional source enters the communication cell 210 after all of the N channels have already been assigned to the N sources positioned in the communication cell 210, the additional source must assign one of the N channels to the additional source to enable the additional source to perform communication.

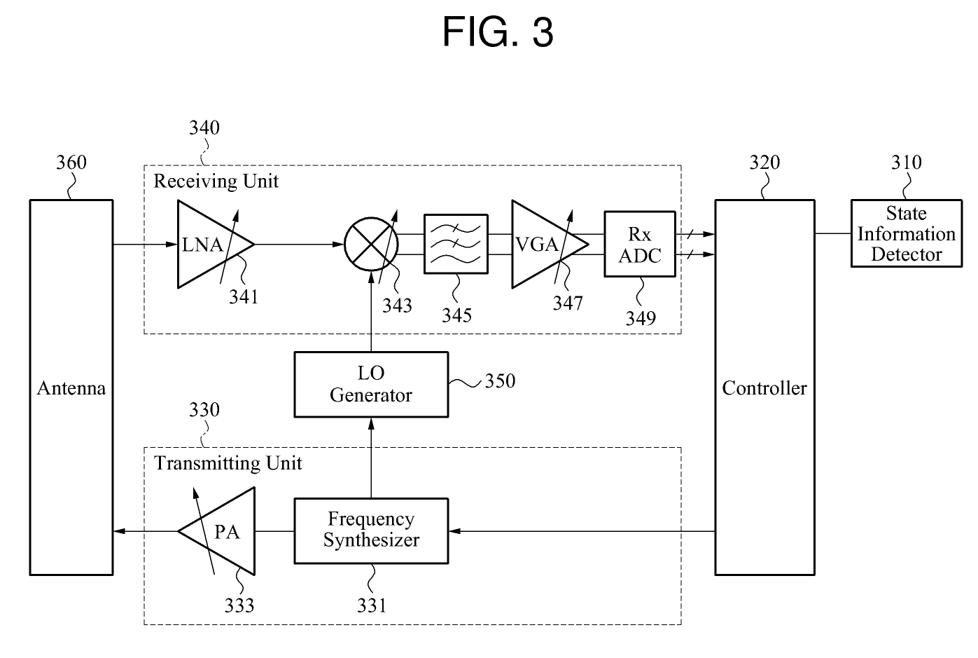

FIG. 3 is a diagram illustrating an example of a communication apparatus in a wireless power transmission system. Referring to FIG. 3, the communication apparatus includes a state information detector 310, a controller 320, a transmitting unit 330, and a receiving unit 340. The communication apparatus of FIG. 3 may be an additional source entering a communication cell after all available channels in the communication cell have already been assigned, or a source desiring to change a channel after all available channels in the communication cell have already been assigned. The communication apparatus may operate in a transmitting mode or a receiving mode when performing communication.

The state information detector 310 detects state information of assigned channels in a communication cell. In this example, the state information detector 310 detects RSSIs and LQIs of the channels as the state information. Also, the state information detector 310 detects channels that are not being used by the sources among the assigned channels in the communication cell. In this example, the state information detector 310 determines whether an assigned channel is being used by a source based on whether a continuous wave signal is received from the source. For example, when a continuous wave signal having a signal level greater than a predetermined value is received from the source through a corresponding channel, the state information detector 310 determines that the source is performing communication via the corresponding channel.

The controller 320 determines a channel to be used for communication based on the state information. In this example, the controller 320 determines the channel to be used for communication based on the RSSIs and the LQIs of the channels. Also, the controller 320 determines the channel to be used for communication is a channel that is not being used by another source. Once controller 320 has determined the channel to be used for communication, the controller 320 uses the determined channel for communication when the determined channel is not being used by another source. The fact that the determined channel is not being by the other source indicates that the other source is not operating in the transmitting mode or the receiving mode to perform communication. The controller 320 determines that a predetermined source is not performing communication when a continuous wave signal is not received from the predetermined source through the determined channel. If the determined channel is being used by another source, the controller 320 determines a different channel to be used for communication based on state information of remaining channels excluding the determined channel.

The transmitting unit 330 performs communication with a target in a power cell via the determined channel when the determined channel is not being used by another source. The transmitting unit 330 transmits, to the target, control information used to efficiently transmit wireless power to the target.

The transmitting unit 330 includes a frequency synthesizer 331 and a power amplifier (PA) 333. The frequency synthesizer 331 synthesizes a frequency to be used for communication. The frequency synthesizer 331 may synthesize the frequency to be used for communication using an oscillator (not shown). The PA 333 amplifies a power of a signal generated by the frequency synthesizer 331 to reduce an effect of noise in a wireless frequency band. The amplified signal is transmitted via an antenna 360. When a frequency used for communication is changed, a local oscillator (LO) generator 350 provides a signal having the changed frequency to the receiving unit 340 based on information about the changed frequency that the LO generator 350 receives from the frequency synthesizer 331. The controller 320 may adjust a power of the PA 333.

The receiving unit 340 receives, from neighboring sources, a channel assignment request message to request assignment of a channel currently being used while the communication apparatus is operating in a receiving mode.

The receiving unit 340 includes a low-noise amplifier (LNA) 341, a mixer 343, a low-pass filter (LPF) 345, a variable gain amplifier (VGA) 347, and a receiving analog-digital converter (Rx ADC) 349. The LNA 341 amplifies a signal received from the antenna 360. In this example, the LNA 341 is disposed close to the antenna 360 to reduce attenuation of a transmission line. Also, the LNA 341 reduces a noise included in the signal. The mixer 343 generates a signal in a new frequency band using two input signals. The mixer 343 generates the signal in the new frequency band by heterodyning the signal amplified by the LNA 341 with the signal provided from the LO generator 350. The mixer 343 lowers a frequency of the signal amplified by the LNA 341 from a wireless frequency band to a baseband. The LPF 345 passes signals with frequencies lower than a cutoff frequency, and attenuates signals with frequencies higher than the cutoff frequency. The VGA 347 amplifies the signal passing through the LPF 345. A gain of the VGA 347 is changed by a control voltage. The Rx ADC 349 converts an analog signal to a digital signal, and provides the digital signal to the controller 320. The controller 320 restores a message by decoding the digital signal. The controller 320 adjusts gains of the LNA 341, the mixer 343, and the VGA 347.

The state information detector 310 performs communication via the determined channel, and detects a number of sources using the determined channel and a channel frequency of the determined channel during a predetermined time period after the communication via the determined channel has been completed. The channel frequency is a frequency of the determined channel being used by the neighboring sources during the predetermined time period. The number of sources using the determined channel is a number of sources attempting to use the determined channel during the predetermined time period. In this example, the predetermined time period is determined based on a minimum amount of time for a source to perform communication. The controller 320 may determine a channel change based on the channel frequency and the number of sources using the determined channel since interference in the determined channel may increase and a quality of the determined channel may decrease, when the channel frequency and the number of sources using the determined channel increase. When the channel change is determined, the controller 320 controls the state information detector 310 to detect state information of a new channel. Also, the controller 320 determines a new channel to be changed to based on the state information of the new channel.

When the channel change and the channel to be changed to are determined, the transmitting unit 330 transmits, to the target in the power cell, information about the channel change and the channel to be changed to via the previously used channel.

The controller 320 controls an overall operation of the communication apparatus, and may perform functions of the state information detector 310, the transmitting unit 330, and the receiving unit 340. To individually describe the functions of the state information detector 310, the transmitting unit 330, and the receiving unit 340, the state information detector 310, the transmitting unit 330, and the receiving unit 340 are separately illustrated in FIG. 3. However, when the communication apparatus of FIG. 3 is actually implemented, the controller 320 may be configured to perform all of the functions of the state information detector 310, the transmitting unit 330, and the receiving unit 340, or only some of these functions.

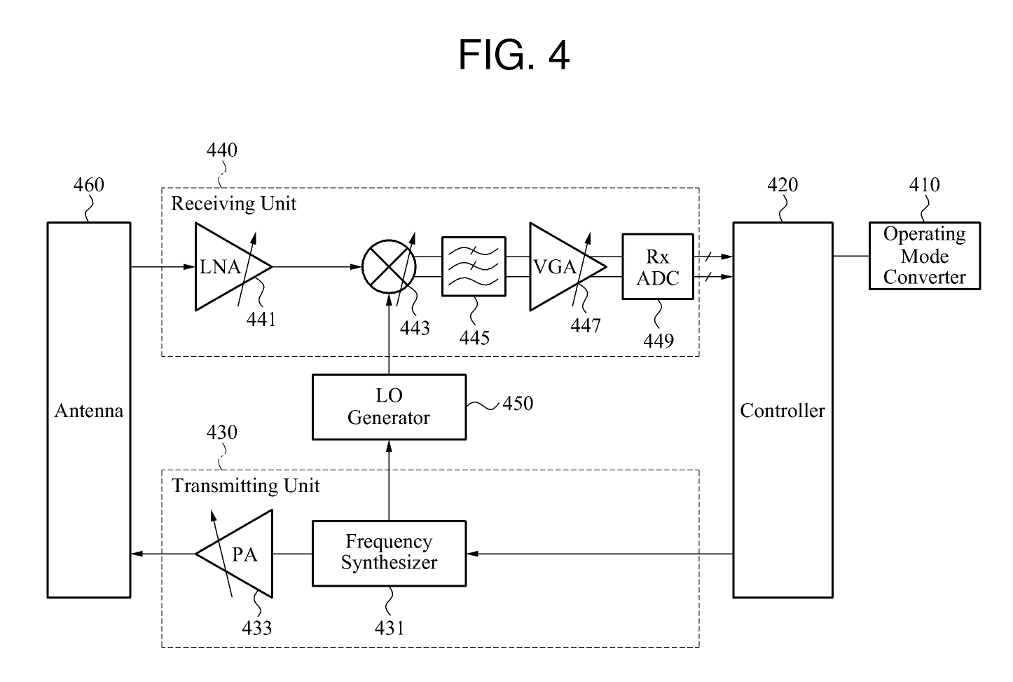

FIG. 4 is a diagram illustrating another example of a communication apparatus in a wireless power transmission system. Referring to FIG. 4, the communication apparatus includes an operating mode converter 410, a controller 420, a transmitting unit 430, and a receiving unit 440. The communication apparatus of FIG. 4 may be a source to which a channel has already been assigned in a communication cell.

The operating mode converter 410 switches an operating mode of the communication apparatus to a transmitting mode or a receiving mode based on a communication operation to be performed by the communication apparatus. The communication apparatus performs communication with a target in a power cell of the communication apparatus via an assigned channel in the transmitting mode. The power cell is an area in which the communication apparatus can transmit power wirelessly. The communication apparatus receives information from the target in the power cell of the communication apparatus in the receiving mode. Also, the communication apparatus receives messages to request assignment of a channel from neighboring sources. Also, the communication apparatus measures state information of a channel based on interference signals from the neighboring sources, other changes in a peripheral environment, and other factors affecting the state of the channel.

When the communication in the transmitting mode or the receiving mode has been completed, the controller 420 controls the communication apparatus to operate in a standby mode to wait to perform a future communication without using the assigned channel while operating in the standby mode. When the communication has been completed and the assigned channel is not being used by the communication apparatus, the neighboring sources in the communication cell and a new source entering the communication cell may use the assigned channel.

When the communication apparatus operates in the transmitting mode to perform communication, the transmitting unit 430 transmits state information of the assigned channel using a continuous wave signal. In this example, the state information of the channel may include information about the communication apparatus, i.e., the source, currently using the channel, information about a target receiving a power from the source, and information about a schedule for the source currently using the channel. The neighboring sources receive the state information of the channel, and determine a channel to be used based on the state information of the channel. For example, the neighboring sources may use the channel while the channel is not being used by the source based on the schedule for the source using the channel.

The transmitting unit 430 includes a frequency synthesizer 431 and a PA 433. The frequency synthesizer 431 synthesizes a frequency to be used for communication. The frequency synthesizer 431 may synthesize the frequency to be used for communication using an oscillator (not shown). The PA 433 amplifies a power of a signal generated by the frequency synthesizer 431 to reduce an effect of noise in a wireless frequency band. The amplified signal is transmitted via an antenna 460. When a frequency used for communication is changed, an LO generator 450 provides a signal having the changed frequency to the receiving unit 440 based on information about the changed frequency that the LO generator 450 receives from the frequency synthesizer 431. The controller 420 may adjust a power of the PA 433.

The receiving unit 440 may receive receives a channel assignment request message from a neighboring source in the communication cell or a new source entering the communication cell. The receiving unit 440 receives the channel assignment request message from the neighboring source or the new source while the communication apparatus is operating in a receiving mode. In response to the channel assignment request message, the communication apparatus may transmit a channel assignment disapproval message indicating that assignment of the channel is disapproved since the channel is currently being used.

The receiving unit 440 includes an LNA 441, a mixer 443, an LPF 445, a VGA 447, and an Rx ADC 449. The LNA 441 amplifies a signal received from the antenna 460. In this example, the LNA 441 is disposed close to the antenna 460 to reduce attenuation of a transmission line. Also, the LNA 441 reduces a noise included in the signal. The mixer 443 generates a signal in a new frequency band using two input signals. The mixer 443 generates the signal in a new frequency band by heterodyning the signal amplified by the LNA 441 with the signal provided by the LO generator 450. The mixer 443 lowers a frequency of the signal amplified by the LNA 441 from a wireless frequency band to a baseband. The LPF 445 passes signals with frequencies lower than a cutoff frequency, and passes signals with frequencies higher than the cutoff frequency. The VGA 447 amplifies the signal passing through the LPF 445. A gain of the VGA 447 is changed by a control voltage. The Rx ADC 449 converts an analog signal output from the VGA 447 to a digital signal, and provides the digital signal to the controller 420. The controller 420 restores a message by decoding the digital signal. The controller 420 adjusts gains of the LNA 441, the mixer 443, and the VGA 447.

The controller 420 controls an overall operation of the communication apparatus, and may perform functions of the operating mode converter 410, the transmitting unit 430, and the receiving unit 440. To individually describe the functions of the operating mode converter 410, the transmitting unit 430, and the receiving unit 440, the operating mode converter 410, the transmitting unit 430, and the receiving unit 440 are separately illustrated in FIG. 4. However, when the communication apparatus of FIG. 4 is actually implemented, the controller 420 may be configured to perform all of the functions of the operating mode converter 410, the transmitting unit 430, and the receiving unit 440, or only some of these functions.

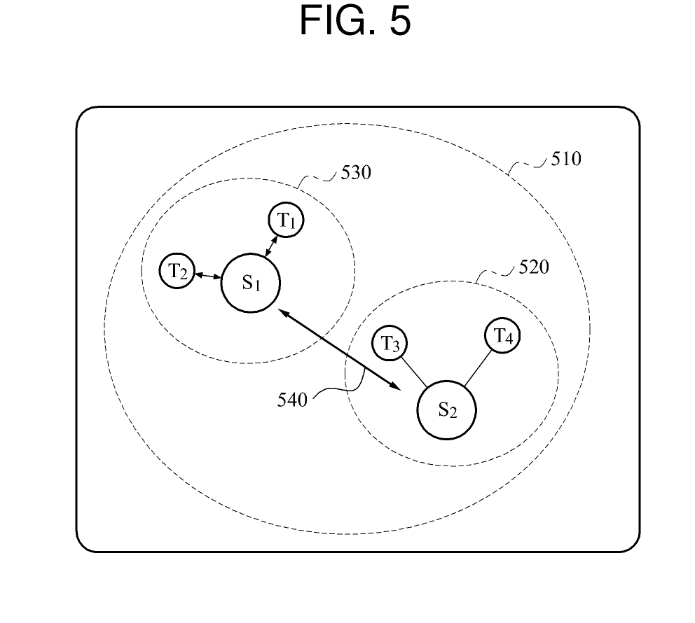

FIG. 5 is a diagram illustrating an example of a process of assigning a channel to an additional source entering a communication cell in a wireless power transmission system. Referring to FIG. 5, it will be assumed that channels have already been assigned to all of the sources in a communication cell 510, and a channel CH₁ has already been assigned to a source S₁. The source S₁ performs communication with a target T₁ and a target T₂ in a power cell 530 of the source S₁ via the channel CH₁. The communication cell 510 is an area in which communication is possible via a plurality of channels, and the power cell 530 is an area in which the source S₁ can transmit power wirelessly.

When a source S₂ enters the communication cell 510, a channel must be assigned to the source S₂ to enable the source S₂ to perform communication. The source S₂ searches for an available channel in the communication cell 510. In this example, the source S₂ searches for an available channel by detecting state information of a channel to be used, based on the state information of the channels. When the source S₂ determines the channel CH₁ to be the channel to be used, the source S₂ needs to determine whether the channel CH₁ is currently being used by another source. When the channel CH₁ is in use by the source S₁, the source S₁ may operate in a transmitting mode or a receiving mode. The source S₁ transmits a continuous wave signal on the channel CH1, thereby informing neighboring sources that the channel CH₁ is being used by the source S₁. The source S₂ may determine whether the channel CH₁ is being used by the source S₁ based on whether the continuous wave signal is received. Also, the source S₂ may determine whether the channel CH₁ is being used by the source S₁ based on an RSSI and an LQI of the channel CH₁.

When the channel CH₁ is not being used by the source S₁, the source S₂ performs communication with a target T₃ and a target T₄ in a power cell 520 of the source S₂ via the channel CH₁.

When the channel CH₁ is being used by the source S₁, the source S₂ searches for another channel other than the channel CH₁. When the channel CH₁ is not being used by the source S₁, the source S₂ may use the channel CH₁, thereby sharing the channel CH₁ with the source S₁.

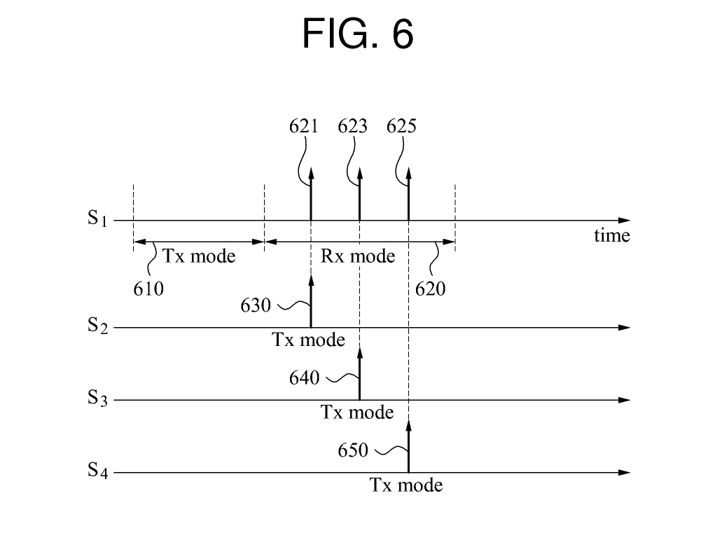

FIG. 6 is a diagram illustrating an example of a process of detecting a channel frequency and a number of sources attempting to use a channel during a predetermined time period performed by a communication apparatus in a wireless power transmission system. Referring to FIG. 6, a source S₁ operates in a transmitting mode 610 or a receiving mode 620. While the source S₁ is operating in the receiving mode 620, a source S₂ attempts to use a channel being used by the source S₁ in a transmitting mode 630, a source S₃ attempts to use the channel being used by the source S₁ in a transmitting mode 640, and a source S₄ attempts to use the channel being used by the source S₁ in a transmitting mode 650. That is, while the source S₁ is operating in the receiving mode 620, three sources S₂, S₃, and S₄ attempt to use the channel being used by the source S₁. While the source S₁ is operating in the receiving mode 620, the source S₁ detects an attempt 621 of the source S₂ to use the channel being used by the source S₁, an attempt 623 of the source S₃ to use the channel being used by the source S₁, an attempt 625 of the source S₄ to use the channel being used by the source S₁, and a channel frequency of the channel being used by the source S₁.

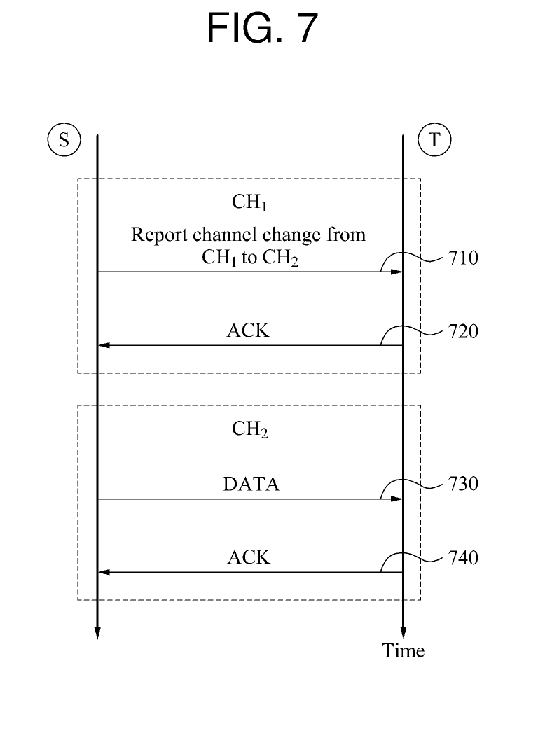

FIG. 7 is a diagram illustrating an example of a process of informing a target of a channel change and transmitting data to the target performed by a source that has determined to change a channel in a wireless power transmission system. Referring to FIG. 7, a source S using a channel CH₁ determines to change a channel based on a number of neighboring sources attempting to use the channel CH₁. The source S determines a channel suitable for communication to be a channel CH₂, and determines to change the channel from the channel CH1 to the channel CH₂. In 710, the source S informs a target T in a power cell of the source S of the channel change from the channel CH₁ to the channel CH₂. In 720, the target T transmits an acknowledgement (ACK) signal indicating that the target T has recognized the channel change from the channel CH₁ to the channel CH₂. In 730, the source S transmits data via the channel CH₂. In 740, the target T transmits an ACK signal indicating that the target T has received the data via the channel CH₂.

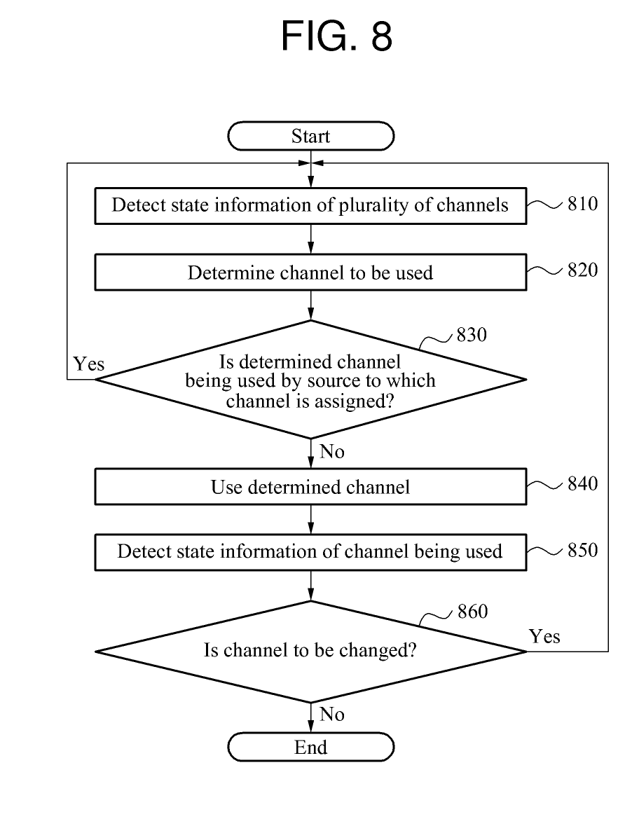

FIG. 8 is a flowchart illustrating an example of a communication method in a wireless power transmission system. In 810, a source detects state information of a plurality of channels that may be assigned in a communication cell. In this example, the state information includes an RSSI and an LQI of a channel.

In 820, the source determines a channel to be used for communication based on the state information of the plurality of channels.

In 830, the source determines whether the determined channel is being used by a source to which the determined channel has already been assigned. When the determined channel is in use by the source to which the determined channel is already assigned, the source may perform the operation of 810 on remaining channels excluding the determined channel.

When the determined channel is not being used by the source to which a channel has already been assigned, the source uses the determined channel in 840. The source performs communication with targets in a power cell of the source via the determined channel. In this example, the source transmits, to the target, information used to efficiently transmit wireless power to the target.

In 850, the source detects state information of the channel that the source is currently using.

In 860, the source determines whether the channel being used by the source is to be changed. For example, the source may determine that the channel being used by the source is to be changed when an RSSI or an LQI of the channel being used by the source decreases, or when a channel frequency of the channel being used by the source is relatively high, and a number of neighboring sources attempting to use the channel being used by the source is greater than a predetermined number. When the source determines that the channel being used by the source is to be changed, the source performs the operation of 810 on the remaining channels excluding the channel being used by the source, and then continues on with the following operations.

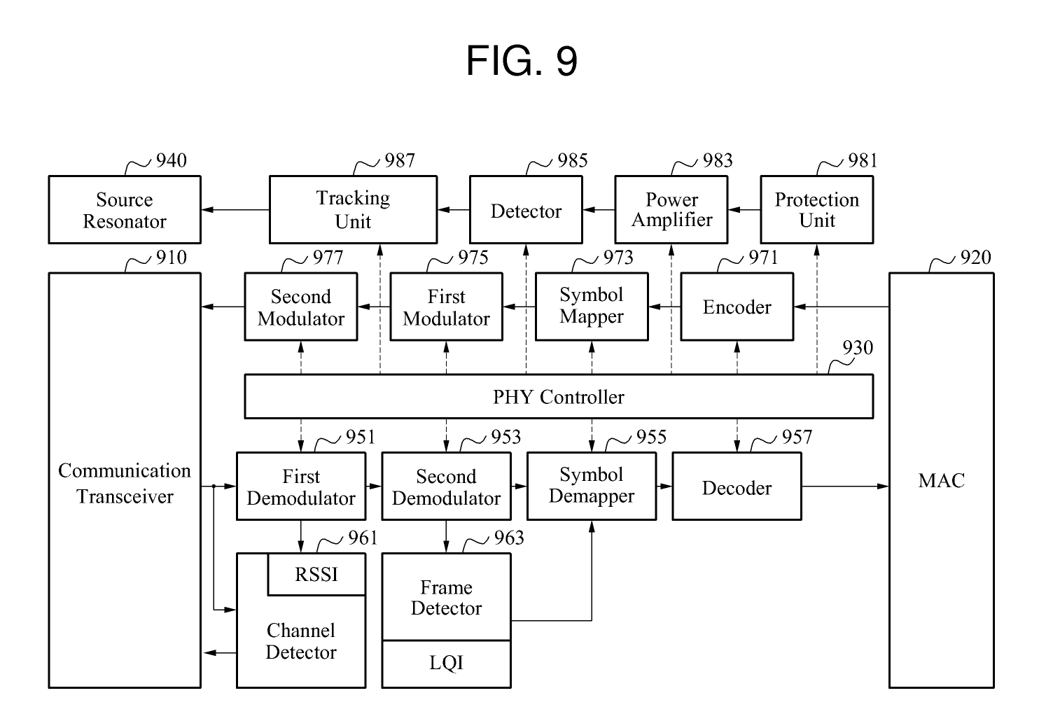

FIG. 9 is a diagram illustrating another example of a communication apparatus in a wireless power transmission system. Referring to FIG. 9, the communication apparatus transmits a signal modulated in a source via a communication transceiver 910 and a medium access control (MAC) 920, and receives a signal modulated in a target via the communication transceiver 910 and the medium access control (MAC) 920. The signals that are transmitted and received may be, for example, the signals shown in FIG. 7. Thus, the communication apparatus of FIG. 9 performs out-of-band communication between the source and the target via the communication transceiver 910, rather than performing in-band communication through the source resonator 940. A PHY controller 930 controls an overall operation associated with modulation of data and generation of wireless power in the communication apparatus. A source resonator 940, for example a wireless power transmitter, transmits wireless power using mutual resonance with a target resonator (not shown).

A first demodulator 951, for example an offset-quadrature phase-shift keying (O-QPSK) demodulator, performs O-QPSK demodulation. A second demodulator 953, for example a chip demodulator, performs demodulation using a pseudo-random noise (PN) sequence. A symbol demapper 955 generates a data symbol corresponding to a quadrature-phase (Q) value and an in-phase (I) value. A decoder 957, for example a Viterbi decoder, decodes the data symbol using a Viterbi scheme. The decoder 957 uses a Viterbi algorithm to decode an encoded bit stream received from the symbol demapper 955 using forward error correction (FEC) based on a convolution code. Although FIG. 9 shows the decoder 957 as being part of the communication apparatus of FIG. 9, the decoder 957 may be provided as a separate element outside the communication apparatus of FIG. 9.

A channel detector 961 detects an RSSI. The RSSI is a value obtained by measuring a strength of an electric wave of data transferred by neighboring devices. A frame detector 963 detects an LQI of a communication link. The LQI is a strength between communication links, and may be calculated from the RSSI.

An encoder 971, for example a convolution encoder, encodes an input signal, and outputs the encoded signal. The encoder 971 may successfully perform bit error checking using an additional bit. Although FIG. 9 shows the encoder 971 as being part of the communication apparatus of FIG. 9, the encoder 971 may be provided as a separate element outside the communication apparatus of FIG. 9. A symbol mapper 973 performs mapping to appropriately arrange symbols based on a designated modulation scheme. A first modulator 975, for example, a direct sequence spread spectrum (DSSS) chip modulator, spreads data to a large-scale code occupying a full bandwidth of a corresponding channel by multiplying a data bit by a random bit pattern, namely a pseudo-random noise (PN) sequence. Such a scheme has a good noise prevention performance, and provides excellent security because the spread data is very difficult to recover without knowing the pseudo-random noise (PN) sequence. A second modulator 977, for example an O-QPSK modulator, performs O-QPSK modulation.

A protection unit 981 prevents an overcurrent from being supplied to a power amplifier 983. The power amplifier 983 generates power required by the target. A detector 985 detects a change in impedance of the target. Additionally, the detector 985 may detect power input to the power amplifier 983. A tracking unit 987 tracks matching impedance between the source and the target. Additionally, the tracking unit 987 may track a resonant frequency between the source and the target.

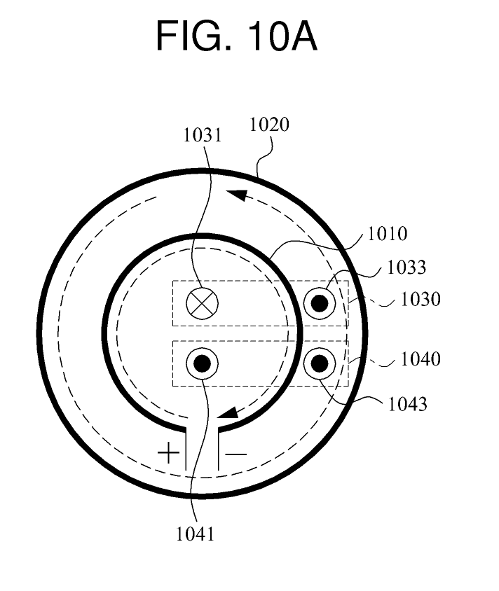

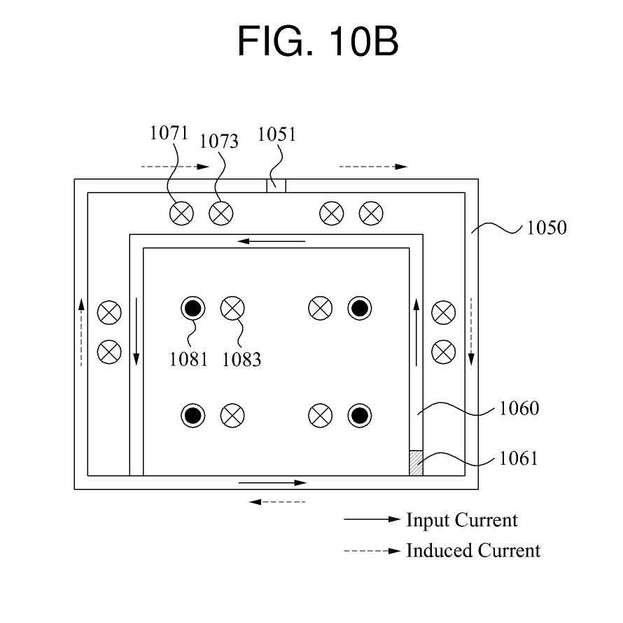

In the following description, the term “resonator” used in the discussion of FIGS. 10A through 12B refers to both a source resonator and a target resonator unless indicated otherwise.

FIGS. 10A and 10B are diagrams illustrating examples of a distribution of a magnetic field in a feeder and a resonator of a wireless power transmitter. When a resonator receives power supplied through a separate feeder, magnetic fields are formed in both the feeder and the resonator.

FIG. 10A illustrates an example of a structure of a wireless power transmitter in which a feeder 1010 and a resonator 1020 do not have a common ground. Referring to FIG. 10A, as an input current flows into a feeder 1010 through a terminal labeled “+” and out of the feeder 1010 through a terminal labeled “−”, a magnetic field 1030 is formed by the input current. A direction 1031 of the magnetic field 1030 inside the feeder 1010 is into the plane of FIG. 10A, and has a phase that is opposite to a phase of a direction 1033 of the magnetic field 1030 outside the feeder 1010, which is out of the plane of FIG. 10A. The magnetic field 1030 formed by the feeder 1010 induces a current to flow in a resonator 1020. The direction of the induced current in the resonator 1020 is opposite to a direction of the input current in the feeder 1010 as indicated by the dashed lines with arrowheads in FIG. 10A.

The induced current in the resonator 1020 forms a magnetic field 1040. Directions of the magnetic field 1040 are the same at all positions inside the resonator 1020, and are out of the plane of FIG. 10A. Accordingly, a direction 1041 of the magnetic field 1040 formed by the resonator 1020 inside the feeder 1010 has the same phase as a direction 1043 of the magnetic field 1040 formed by the resonator 1020 outside the feeder 1010.

Consequently, when the magnetic field 1030 formed by the feeder 1010 and the magnetic field 1040 formed by the resonator 1020 are combined, the strength of the total magnetic field inside the resonator 1020 decreases inside the feeder 1010, but increases outside the feeder 1010. In an example in which power is supplied to the resonator 1020 through the feeder 1010 configured as illustrated in FIG. 10A, the strength of the total magnetic field decreases in the center of the resonator 1020, but increases outside the resonator 1020. In another example in which a magnetic field is randomly or not uniformly distributed in the resonator 1020, it is difficult to perform impedance matching since an input impedance will frequently vary. Additionally, when the strength of the total magnetic field increases, an efficiency of wireless power transmission increases. Conversely, when the strength of the total magnetic field decreases, the efficiency of wireless power transmission decreases. Accordingly, the power transmission efficiency is reduced on average when the magnetic field is randomly or non uniformly distributed in the resonator 1020 compared to when the magnetic field is uniformly distributed in the resonator 1020.

FIG. 10B illustrates an example of a structure of a wireless power transmitter in which a resonator 1050 and a feeder 1060 have a common ground. The resonator 1050 includes a capacitor 1051. The feeder 1060 receives a radio frequency (RF) signal via a port 1061. When the RF signal is input to the feeder 1060, an input current is generated in the feeder 1060. The input current flowing in the feeder 1060 forms a magnetic field, and a current is induced in the resonator 1050 by the magnetic field. Additionally, another magnetic field is formed by the induced current flowing in the resonator 1050. In this example, a direction of the input current flowing in the feeder 1060 has a phase opposite to a phase of a direction of the induced current flowing in the resonator 1050. Accordingly, in a region between the resonator 1050 and the feeder 1060, a direction 1071 of the magnetic field formed by the input current has the same phase as a direction 1073 of the magnetic field formed by the induced current, and thus the strength of the total magnetic field increases in the region between the resonator 1050 and the feeder 1060. Conversely, inside the feeder 1060, a direction 1081 of the magnetic field formed by the input current has a phase opposite to a phase of a direction 1083 of the magnetic field formed by the induced current, and thus the strength of the total magnetic field decreases inside the feeder 1060. Therefore, the strength of the total magnetic field decreases in the center of the resonator 1050, but increases outside the resonator 1050.

An input impedance may be adjusted by adjusting an internal area of the feeder 1060. The input impedance refers to an impedance viewed in a direction from the feeder 1060 to the resonator 1050. When the internal area of the feeder 1060 is increased, the input impedance is increased. Conversely, when the internal area of the feeder 1060 is decreased, the input impedance is decreased. However, if the magnetic field is randomly or not uniformly distributed in the resonator 1050, a value of the input impedance may vary based on a location of a target device even if the internal area of the feeder 1060 has been adjusted to adjust the input impedance to match an output impedance of a power amplifier for a specific location of the target device. Accordingly, a separate matching network may be required to match the input impedance to the output impedance of the power amplifier. For example, when the input impedance is increased, a separate matching network may be used to match the increased input impedance to a relatively low output impedance of the power amplifier.

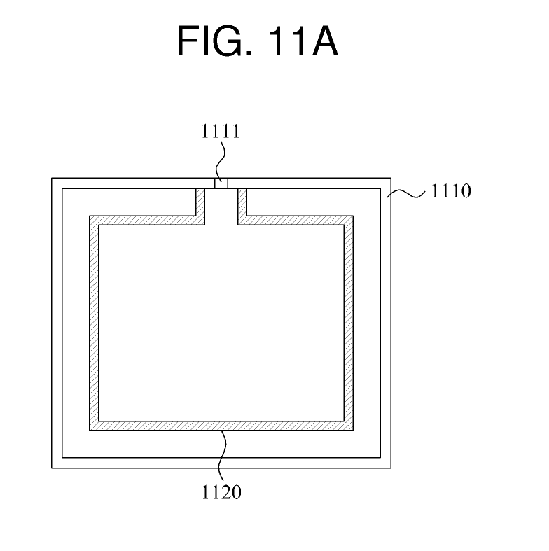

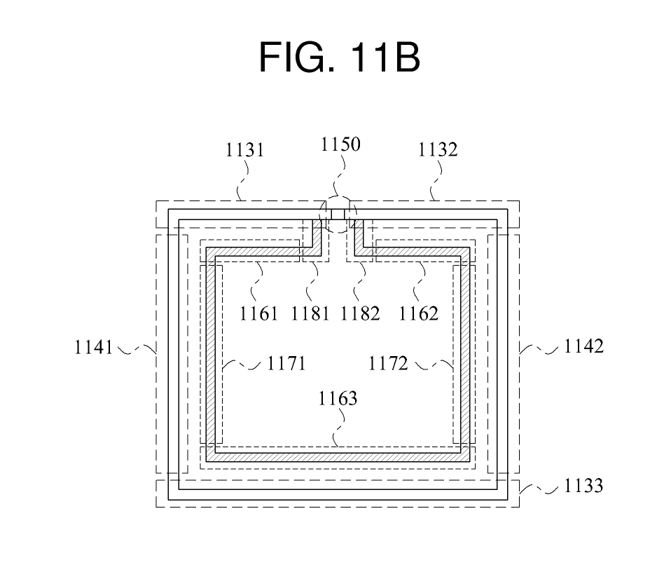

FIGS. 11A and 11B are diagrams illustrating an example of a wireless power transmitter including a resonator and a feeding unit. Referring to FIG. 11A, the wireless power transmitter includes a resonator 1110 and a feeding unit 1120. The resonator 1110 includes a capacitor 1111. The feeding unit 1120 is electrically connected to both ends of the capacitor 1111.

FIG. 11B is a diagram illustrating in greater detail a structure of the wireless power transmitter of FIG. 11A. The resonator 1110 includes a first transmission line (not identified by a reference numeral in FIG. 11B, but formed by various elements in FIG. 11B as discussed below), a first conductor 1141, a second conductor 1142, and at least one capacitor 1150.

The capacitor 1150 is inserted in series between a first signal conducting portion 1131 and a second signal conducting portion 1132, causing an electric field to be concentrated in the capacitor 1150. Generally, a transmission line includes at least one conductor in an upper portion of the transmission line, and at least one conductor in a lower portion of the transmission line. A current may flow through the at least one conductor disposed in the upper portion of the transmission line, and the at least one conductor disposed in the lower portion of the transmission line may be electrically grounded. In this example, a conductor disposed in an upper portion of the first transmission line in FIG. 11B is separated into two portions that will be referred to as the first signal conducting portion 1131 and the second signal conducting portion 1132. A conductor disposed in a lower portion of the first transmission line in FIG. 11B will be referred to as a first ground conducting portion 1133.

As illustrated in FIG. 11B, the resonator 1110 has a generally two-dimensional (2D) structure. The first transmission line includes the first signal conducting portion 1131 and the second signal conducting portion 1132 in the upper portion of the first transmission line, and includes the first ground conducting portion 1133 in the lower portion of the first transmission line. The first signal conducting portion 1131 and the second signal conducting portion 1132 are disposed to face the first ground conducting portion 1133. A current flows through the first signal conducting portion 1131 and the second signal conducting portion 1132.

One end of the first signal conducting portion 1131 is connected to one end of the first conductor 1141, the other end of the first signal conducting portion 1131 is connected to one end of the capacitor 1150, and the other end of the first conductor 1141 is connected to one end of the first ground conducting portion 1133. One end of the second signal conducting portion 1132 is connected to one end of the second conductor 1142, the other end of the second signal conducting portion 1132 is connected to the other end of the capacitor 1150, and the other end of the second conductor 1142 is connected to the other end of the first ground conducting portion 1133. Accordingly, the first signal conducting portion 1131, the second signal conducting portion 1132, the first ground conducting portion 1133, the first conductor 1141, and the second conductor 1142 are connected to each other, causing the resonator 1110 to have an electrically closed loop structure. The term “loop structure” includes a polygonal structure, a circular structure, a rectangular structure, and any other geometrical structure that is closed, i.e., that does not have any opening in its perimeter. The expression “having a loop structure” indicates a structure that is electrically closed.

The capacitor 1150 is inserted into an intermediate portion of the first transmission line. In the example in FIG. 11B, the capacitor 1150 is inserted into a space between the first signal conducting portion 1131 and the second signal conducting portion 1132. The capacitor 1150 may be a lumped element capacitor, a distributed capacitor, or any other type of capacitor known to one of ordinary skill in the art. For example, a distributed element capacitor may include a zigzagged conductor line and a dielectric material having a relatively high permittivity disposed between parallel portions of the zigzagged conductor line.

The capacitor 1150 inserted into the first transmission line may cause the resonator 1110 to have a characteristic of a metamaterial. A metamaterial is a material having a predetermined electrical property that is not found in nature, and thus may have an artificially designed structure. All materials existing in nature have a magnetic permeability and a permittivity. Most materials have a positive magnetic permeability and/or a positive permittivity.

For most materials, a right-hand rule may be applied to an electric field, a magnetic field, and a Poynting vector of the materials, so the materials may be referred to as right-handed materials (RHMs). However, a metamaterial having a magnetic permeability and/or a permittivity that is not found in nature may be classified into an epsilon negative (ENG) material, a mu negative (MNG) material, a double negative (DNG) material, a negative refractive index (NRI) material, a left-handed (LH) material, and other metamaterial classification known to one of ordinary skill in the art based on a sign of the magnetic permeability of the metamaterial and a sign of the permittivity of the metamaterial.

If the capacitor 1150 is a lumped element capacitor and a capacitance of the capacitor 1150 is appropriately determined, the resonator 1110 may have a characteristic of a metamaterial. If the resonator 1110 is caused to have a negative magnetic permeability by appropriately adjusting the capacitance of the capacitor 1150, the resonator 1110 may also be referred to as an MNG resonator. Various criteria may be applied to determine the capacitance of the capacitor 1150. For example, the various criteria may include a criterion for enabling the resonator 1110 to have the characteristic of the metamaterial, a criterion for enabling the resonator 1110 to have a negative magnetic permeability at a target frequency, a criterion for enabling the resonator 1110 to have a zeroth order resonance characteristic at the target frequency, and any other suitable criterion. Based on any one or any combination of the aforementioned criteria, the capacitance of the capacitor 1150 may be appropriately determined.

The resonator 1110, hereinafter referred to as the MNG resonator 1110, may have a zeroth order resonance characteristic of having a resonant frequency when a propagation constant is “0”. If the MNG resonator 1110 has the zeroth order resonance characteristic, the resonant frequency is independent of a physical size of the MNG resonator 1110. By changing the capacitance of the capacitor 1150, the resonant frequency of the MNG resonator 1110 may be changed without changing the physical size of the MNG resonator 1110.

In a near field, the electric field is concentrated in the capacitor 1150 inserted into the first transmission line, causing the magnetic field to become dominant in the near field. The MNG resonator 1110 has a relatively high Q-factor when the capacitor 1150 is a lumped element capacitor, thereby increasing a power transmission efficiency. The Q-factor indicates a level of an ohmic loss or a ratio of a reactance with respect to a resistance in the wireless power transmission. As will be understood by one of ordinary skill in the art, the efficiency of the wireless power transmission will increase as the Q-factor increases.

Although not illustrated in FIG. 11B, a magnetic core passing through the MNG resonator 1110 may be provided to increase a power transmission distance.

Referring to FIG. 11B, the feeding unit 1120 includes a second transmission line (not identified by a reference numeral in FIG. 11B, but formed by various elements in FIG. 11B as discussed below), a third conductor 1171, a fourth conductor 1172, a fifth conductor 1181, and a sixth conductor 1182.

The second transmission line includes a third signal conducting portion 1161 and a fourth signal conducting portion 1162 in an upper portion of the second transmission line, and includes a second ground conducting portion 1163 in a lower portion of the second transmission line. The third signal conducting portion 1161 and the fourth signal conducting portion 1162 are disposed to face the second ground conducting portion 1163. A current flows through the third signal conducting portion 1161 and the fourth signal conducting portion 1162.

One end of the third signal conducting portion 1161 is connected to one end of the third conductor 1171, the other end of the third signal conducting portion 1161 is connected to one end of the fifth conductor 1181, and the other end of the third conductor 1171 is connected to one end of the second ground conducting portion 1163. One end of the fourth signal conducting portion 1162 is connected to one end of the fourth conductor 1172, the other end of the fourth signal conducting portion 1162 is connected to one end of the sixth conductor 1182, and the other end of the fourth conductor 1172 is connected to the other end of the second ground conducting portion 1163. The other end of the fifth conductor 1181 is connected to the first signal conducting portion 1131 at or near where the first signal conducting portion 1131 is connected to one end of the capacitor 1150, and the other end of the sixth conductor 1182 is connected to the second signal conducting portion 1132 at or near where the second signal conducting portion 1132 is connected to the other end of the capacitor 1150. Thus, the fifth conductor 1181 and the sixth conductor 1182 are connected in parallel to both ends of the capacitor 1150. The fifth conductor 1181 and the sixth conductor 1182 are used as an input port to receive an RF signal as an input.

Accordingly, the third signal conducting portion 1161, the fourth signal conducting portion 1162, the second ground conducting portion 1163, the third conductor 1171, the fourth conductor 1172, the fifth conductor 1181, the sixth conductor 1182, and the resonator 1110 are connected to each other, causing the resonator 1110 and the feeding unit 1120 to have an electrically closed loop structure. The term “loop structure” includes a polygonal structure, a circular structure, a rectangular structure, and any other geometrical structure that is closed, i.e., that does not have any opening in its perimeter. The expression “having a loop structure” indicates a structure that is electrically closed.

If an RF signal is input to the fifth conductor 1181 or the sixth conductor 1182, input current flows through the feeding unit 1120 and the resonator 1110, generating a magnetic field that induces a current in the resonator 1110. A direction of the input current flowing through the feeding unit 1120 is identical to a direction of the induced current flowing through the resonator 1110, thereby causing the strength of the total magnetic field to increase in the center of the resonator 1110, and decrease near the outer periphery of the resonator 1110.

An input impedance is determined by an area of a region between the resonator 1110 and the feeding unit 1120. Accordingly, a separate matching network used to match the input impedance to an output impedance of a power amplifier may not be necessary. However, if a matching network is used, the input impedance may be adjusted by adjusting a size of the feeding unit 1120, and accordingly a structure of the matching network may be simplified. The simplified structure of the matching network reduces a matching loss of the matching network.

The second transmission line, the third conductor 1171, the fourth conductor 1172, the fifth conductor 1181, and the sixth conductor 1182 of the feeding unit 1120 may have a structure identical to the structure of the resonator 1110. For example, if the resonator 1110 has a loop structure, the feeding unit 1120 may also have a loop structure. As another example, if the resonator 1110 has a circular structure, the feeding unit 1120 may also have a circular structure.

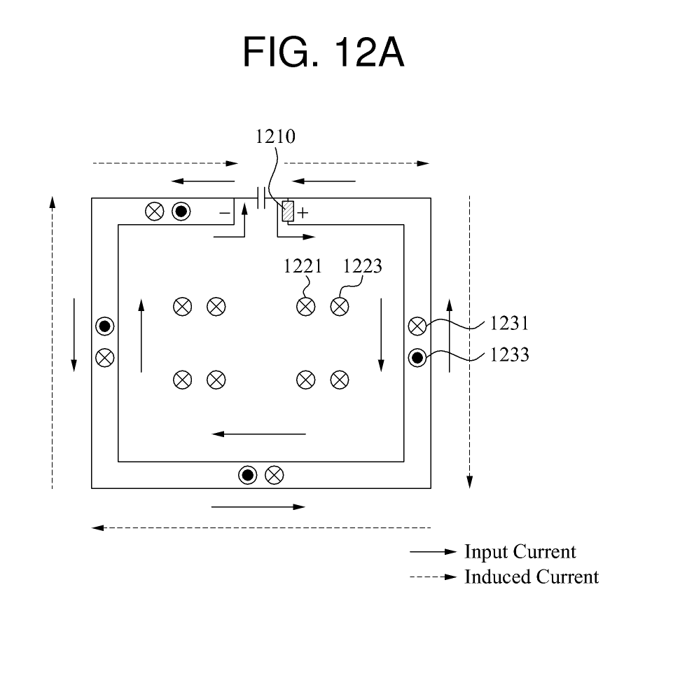

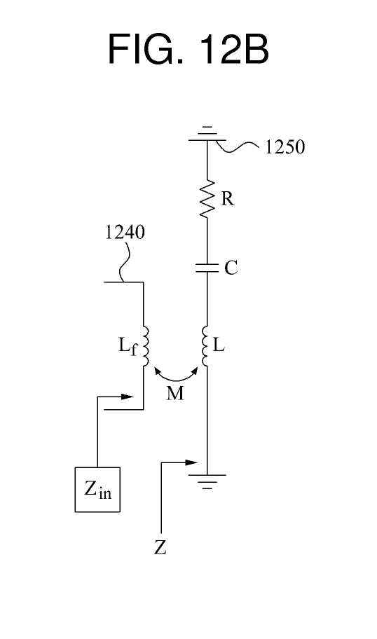

FIG. 12A is a diagram illustrating an example of a distribution of a magnetic field inside a resonator produced by feeding of a feeding unit. FIG. 12A more simply illustrates the resonator 1110 and the feeding unit 1120 of FIGS. 11A and 11B, and the names of the various elements in FIG. 11B will be used in the following description of FIG. 12A without reference numerals.

A feeding operation may be an operation of supplying power to a source resonator in wireless power transmission, or an operation of supplying AC power to a rectification unit in wireless power transmission. FIG. 12A illustrates a direction of an input current flowing in the feeding unit, and a direction of an induced current flowing in the source resonator. Additionally, FIG. 12A illustrates a direction of a magnetic field formed by the input current of the feeding unit, and a direction of a magnetic field formed by the induced current of the source resonator.

Referring to FIG. 12A, the fifth conductor or the sixth conductor of the feeding unit may be used as an input port 1210. In FIG. 12A, the sixth conductor of the feeding unit is being used as the input port 1210. An RF signal is input to the input port 1210. The RF signal may be output from a power amplifier. The power amplifier may increase and decrease an amplitude of the RF signal based on a power requirement of a target device. The RF signal input to the input port 1210 is represented in FIG. 12A as an input current flowing in the feeding unit. The input current flows in a clockwise direction in the feeding unit along the second transmission line of the feeding unit. The fifth conductor and the sixth conductor of the feeding unit are electrically connected to the resonator. More specifically, the fifth conductor of the feeding unit is connected to the first signal conducting portion of the resonator, and the sixth conductor of the feeding unit is connected to the second signal conducting portion of the resonator. Accordingly, the input current flows in both the resonator and the feeding unit. The input current flows in a counterclockwise direction in the resonator along the first transmission line of the resonator. The input current flowing in the resonator generates a magnetic field, and the magnetic field induces a current in the resonator. The induced current flows in a clockwise direction in the resonator along the first transmission line of the resonator. The induced current in the resonator transfers energy to the capacitor of the resonator, and also generates a magnetic field. In FIG. 12A, the input current flowing in the feeding unit and the resonator is indicated by solid lines with arrowheads, and the induced current flowing in the resonator is indicated by dashed lines with arrowheads.

A direction of a magnetic field generated by a current is determined based on the right-hand rule. As illustrated in FIG. 12A, inside the feeding unit, a direction 1221 of the magnetic field generated by the input current flowing in the feeding unit is identical to a direction 1223 of the magnetic field generated by the induced current flowing in the resonator. Accordingly, the strength of the total magnetic field increases inside the feeding unit.

In contrast, as illustrated in FIG. 12A, in a region between the feeding unit and the resonator, a direction 1233 of the magnetic field generated by the input current flowing in the feeding unit is opposite to a direction 1231 of the magnetic field generated by the induced current flowing in the source resonator. Accordingly, the strength of the total magnetic field decreases in the region between the feeding unit and the resonator.

Typically, in a resonator having a loop structure, a strength of a magnetic field decreases in the center of the resonator, and increases near an outer periphery of the resonator. However, referring to FIG. 12A, since the feeding unit is electrically connected to both ends of the capacitor of the resonator, the direction of the induced current in the resonator is identical to the direction of the input current in the feeding unit. Since the direction of the induced current in the resonator is identical to the direction of the input current in the feeding unit, the strength of the total magnetic field increases inside the feeding unit, and decreases outside the feeding unit. As a result, due to the feeding unit, the strength of the total magnetic field increases in the center of the resonator having the loop structure, and decreases near an outer periphery of the resonator, thereby compensating for the normal characteristic of the resonator having the loop structure in which the strength of the magnetic field decreases in the center of the resonator, and increases near the outer periphery of the resonator. Thus, the strength of the total magnetic field may be constant inside the resonator.

A power transmission efficiency for transferring wireless power from a source resonator to a target resonator is proportional to the strength of the total magnetic field generated in the source resonator. Accordingly, when the strength of the total magnetic field increases inside the source resonator, the power transmission efficiency also increases.

FIG. 12B is a diagram illustrating examples of equivalent circuits of a feeding unit and a resonator. Referring to FIG. 12B, a feeding unit 1240 and a resonator 1250 may be represented by the equivalent circuits in FIG. 12B. The feeding unit 1240 is represented as an inductor having an inductance L_{f}, and the resonator 1250 is represented as a series connection of an inductor having an inductance L coupled to the inductance L_{f} of the feeding unit 1240 by a mutual inductance M, a capacitor having a capacitance C, and a resistor having a resistance R. An example of an input impedance Zᵢₙ viewed in a direction from the feeding unit 1240 to the resonator 1250 may be expressed by the following Equation 4:

$${Z}_{in} = \frac{{( ω M )}^{2}}{Z} \qquad ( 4 )$$

In Equation 4, M denotes a mutual inductance between the feeding unit 1240 and the resonator 1250, ω denotes a resonant frequency of the feeding unit 1240 and the resonator 1250, and Z denotes an impedance viewed in a direction from the resonator 1250 to a target device. As can be seen from Equation 4, the input impedance Zᵢₙ is proportional to the square of the mutual inductance M. Accordingly, the input impedance Zᵢₙ may be adjusted by adjusting the mutual inductance M. The mutual inductance M depends on an area of a region between the feeding unit 1240 and the resonator 1250. The area of the region between the feeding unit 1240 and the resonator 1250 may be adjusted by adjusting a size of the feeding unit 1240, thereby adjusting the mutual inductance M and the input impedance Zᵢₙ. Since the input impedance Zᵢₙ may be adjusted by adjusting the size of the feeding unit 1240, it may be unnecessary to use a separate matching network to perform impedance matching with an output impedance of a power amplifier.

In a target resonator and a feeding unit included in a wireless power receiver, a magnetic field may be distributed as illustrated in FIG. 12A. For example, the target resonator may receive wireless power from a source resonator via magnetic coupling. The received wireless power induces a current in the target resonator. The induced current in the target resonator generates a magnetic field, which induces a current in the feeding unit. If the target resonator is connected to the feeding unit as illustrated in FIG. 12A, a direction of the induced current flowing in the target resonator will be identical to a direction of the induced current flowing in the feeding unit. Accordingly, for the reasons discussed above in connection with FIG. 12A, the strength of the total magnetic field will increase inside the feeding unit, and will decrease in a region between the feeding unit and the target resonator.

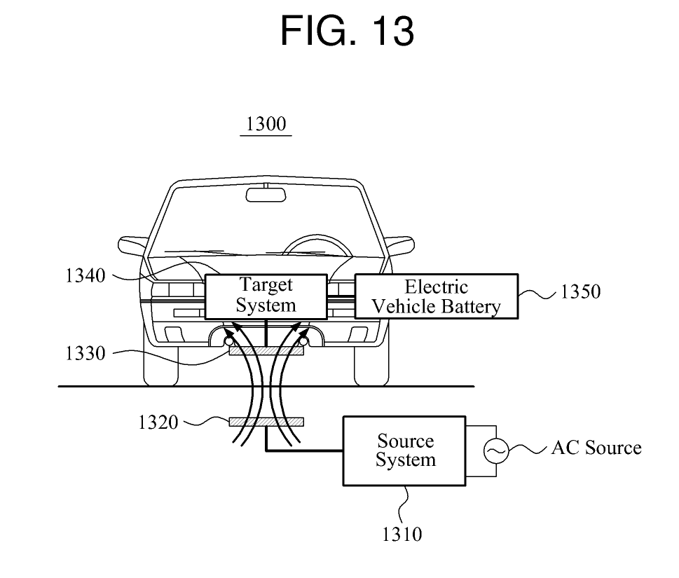

FIG. 13 is a diagram illustrating an example of an electric vehicle charging system. Referring to FIG. 13, an electric vehicle charging system 1300 includes a source system 1310, a source resonator 1320, a target resonator 1330, a target system 1340, and an electric vehicle battery 1350.

In one example, the electric vehicle charging system 1300 has a structure similar to the structure of the wireless power transmission and charging system of FIG. 1. The source system 1310 and the source resonator 1320 in the electric vehicle charging system 1300 operate as a source. The target resonator 1330 and the target system 1340 in the electric vehicle charging system 1300 operate as a target.

In one example, the source system 1310 includes an alternating current-to-direct current (AC/DC) converter, a power detector, a power converter, a control and communication (control/communication) unit similar to those of the source device 110 of FIG. 1. In one example, the target system 1340 includes a rectification unit, a DC-to-DC (DC/DC) converter, a switch unit, a charging unit, and a control/communication unit similar to those of the target device 120 of FIG. 1. The electric vehicle battery 1350 is charged by the target system 1340. The electric vehicle charging system 1300 may use a resonant frequency in a band of a few kHz to tens of MHz.

The source system 1310 generates power based on a type of the vehicle being charged, a capacity of the electric vehicle battery 1350, and a charging state of the electric vehicle battery 1350, and wirelessly transmits the generated power to the target system 1340 via a magnetic coupling between the source resonator 1320 and the target resonator 1330.

The source system 1310 may control an alignment of the source resonator 1320 and the target resonator 1330. For example, when the source resonator 1320 and the target resonator 1330 are not aligned, the controller of the source system 1310 may transmit a message to the target system 1340 to control the alignment of the source resonator 1320 and the target resonator 1330.

For example, when the target resonator 1330 is not located in a position enabling maximum magnetic coupling, the source resonator 1320 and the target resonator 1330 are not properly aligned. When a vehicle does not stop at a proper position to accurately align the source resonator 1320 and the target resonator 1330, the source system 1310 may instruct a position of the vehicle to be adjusted to control the source resonator 1320 and the target resonator 1330 to be aligned. However, this is just an example, and other methods of aligning the source resonator 1320 and the target resonator 1330 may be used.

The source system 1310 and the target system 1340 may transmit or receive an ID of a vehicle and exchange various messages by performing communication with each other.

The descriptions of FIGS. 2A through 12B are also applicable to the electric vehicle charging system 1300. However, the electric vehicle charging system 1300 may use a resonant frequency in a band of a few kHz to tens of MHz, and may wirelessly transmit power that is equal to or higher than tens of watts to charge the electric vehicle battery 1350.

The control/communication unit 115, the control/communication unit 126, the state information detector 310, the controller 320, the transmitting unit 330, the receiving unit 340, the operating mode converter 410, the controller 420, the transmitting unit 430, the receiving unit 440, the communication transceiver 910, the MAC 920, the PHY controller 930, the first demodulator 951, the second demodulator 953, the symbol demapper 955, the decoder 957, the channel detector 961, the frame detector 963, the encoder 971, the symbol mapper 973, the first modulator 975, and second modulator 977, the protection unit 981, the power amplifier 983, the detector 985, the tracking unit 987, the source system 1310, and the target system 1340 described above may be implemented using one or more hardware components, one or more software components, or a combination of one or more hardware components and one or more software components.

A hardware component may be, for example, a physical device that physically performs one or more operations, but is not limited thereto. Examples of hardware components include amplifiers, low-pass filters, high-pass filters, band-pass filters, analog-to-digital converters, digital-to-analog converters, frequency synthesizers, LO generators, and processing devices.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

A processing device configured to implement a software component to perform an operation A may include a processor programmed to run software or execute instructions to control the processor to perform operation A. In addition, a processing device configured to implement a software component to perform an operation A, an operation B, and an operation C may have various configurations, such as, for example, a processor configured to implement a software component to perform operations A, B, and C; a first processor configured to implement a software component to perform operation A, and a second processor configured to implement a software component to perform operations B and C; a first processor configured to implement a software component to perform operations A and B, and a second processor configured to implement a software component to perform operation C; a first processor configured to implement a software component to perform operation A, a second processor configured to implement a software component to perform operation B, and a third processor configured to implement a software component to perform operation C; a first processor configured to implement a software component to perform operations A, B, and C, and a second processor configured to implement a software component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

Software or instructions for controlling a processing device to implement a software component may include a computer program, a piece of code, an instruction, or some combination thereof, for independently or collectively instructing or configuring the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

For example, the software or instructions and any associated data, data files, and data structures may be recorded, stored, or fixed in one or more non-transitory computer-readable storage media. A non-transitory computer-readable storage medium may be any data storage device that is capable of storing the software or instructions and any associated data, data files, and data structures so that they can be read by a computer system or processing device. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, or any other non-transitory computer-readable storage medium known to one of ordinary skill in the art.

Functional programs, codes, and code segments for implementing the examples disclosed herein can be easily constructed by a programmer skilled in the art to which the examples pertain based on the drawings and their corresponding descriptions as provided herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A communication apparatus in a wireless power transmission system, the communication apparatus comprising:
a state information detector configured to detect state information of a plurality of channels available in a communication cell when all of the plurality of channels have already been respectively assigned to a plurality of sources configured to transmit wireless power; and
a controller configured to:
determine one of the plurality of channels to be used for communication by the communication apparatus based on the state information;
determine whether the determined channel is being used by a respective one of the plurality of sources to which the determined channel has already been assigned; and
determine whether the determined channel is to be used by the communication apparatus depending on a result of the determination of whether the determined channel is being used.

2. The communication apparatus of claim 1, wherein the state information detector is further configured to detect, as the state information of the plurality of channels, a received signal strength indicator (RSSI) of each of the plurality of channels, a Link Quality Indicator (LQI) of each of the plurality of channels, and whether each of the plurality of channels is being used by a respective one of the plurality of sources to which the plurality of channels have already been respectively assigned.

3. The communication apparatus of claim 2, wherein the state information detector is further configured to detect whether each of the plurality of channels is being used by the plurality of sources to which the plurality of channels have already been respectively assigned by detecting whether the communication apparatus receives a respective continuous wave signal from each of the plurality of sources.

4. The communication apparatus of claim 1, wherein the controller is further configured to determine another one of the plurality of channels to be used by the communication apparatus based on state information of remaining ones of the plurality of channels excluding the determined channel when the determined channel is being used by the respective one of the plurality of sources to which the determined channel has already been assigned.

5. The communication apparatus of claim 1, further comprising a transmitting unit configured to transmit control information to a target in a power cell of the communication apparatus that is configured to receive wireless power from the communication apparatus via the determined channel when the determined channel is not being used by the respective one of the plurality of sources to which the determined channel has already been assigned.

6. The communication apparatus of claim 5, further comprising a receiving unit configured to receive, from any of the plurality of sources or any new source that may enter the communication cell, a channel assignment request message to request assignment of the determined channel while the communication apparatus is operating in a receiving mode.

7. The communication apparatus of claim 5, wherein the transmitting unit is further configured to perform communication with the target via the determined channel; and
the state information detector is further configured to detect a number of sources attempting to use the determined channel and a channel frequency of the determined channel during a predetermined time period after the communication with the target has been completed.

8. The communication apparatus of claim 7, wherein the predetermined time period is determined based on a minimum amount of time required for a source to perform communication with a target.

9. The communication apparatus of claim 7, wherein the controller is further configured to determine whether the determined channel is to be changed based on the detected number of sources attempting to use the determined channel during the predetermined time period and the detected channel frequency.

10. The communication apparatus of claim 9, wherein the transmitting unit is further configured to transmit information indicating that the determined channel is to be changed and information about a channel to be changed to the target via the determined channel when the controller determines that the determined channel is to be changed.

11. A communication apparatus in a wireless power transmission system, the communication apparatus comprising:
an operating mode converter configured to switch an operating mode of the communication apparatus to a transmitting mode or a receiving mode based on a communication operation to be performed by the communication apparatus when all of a plurality of channels available in a communication cell have already been respectively assigned to a plurality of sources configured to transmit wireless power, the communication apparatus being one of the plurality of sources; and
a controller configured to control the communication apparatus to operate in a standby mode to wait to perform a future communication operation without using the respective one of the plurality of channels that has been assigned to the communication apparatus while operating in the standby mode when the communication to be performed by the communication apparatus has been completed.

12. The communication apparatus of claim 11, further comprising a transmitting unit configured to transmit state information of the respective one of the plurality of channels that has been assigned to the communication apparatus using a continuous wave signal when the communication apparatus is performing a communication operation in the transmitting mode.

13. The communication apparatus of claim 12, wherein the state information comprises information about the communication apparatus, information about a target that is configured to receive wireless power from the communication apparatus, and information about a schedule for the communication apparatus.

14. The communication apparatus of claim 11, further comprising a receiving unit configured to receive a channel assignment request message to request assignment of the determined channel from any of the plurality of sources excluding the communication apparatus and any new source that may enter the communication cell.

15. A communication method in a wireless power transmission system, the communication method comprising:
detecting state information of a plurality of channels available in a communication cell when all of the plurality of channels have already been respectively assigned to a plurality of sources configured to transmit wireless power;
determining a channel to be used for communication based on the state information;
determining whether the determined channel is being used by a respective one of the plurality of sources to which the determined channel has already been assigned; and
determining whether the determined channel is to be used for communication depending on a result of the determining of whether the determined channel is being used.

16. The communication method of claim 15, wherein the detecting of the state information comprises detecting, as the state information, a received signal strength indicator (RSSI) of each of the plurality of channels, a Link Quality Indicator (LQI) of each of the plurality of channels, and whether each of the plurality of channels is being used by a respective one of the plurality of sources to which the plurality of channels have already been respectively assigned.

17. The communication method of claim 15, further comprising determining another one of the plurality of channels to be used to perform communication based on state information of remaining ones of the plurality of channels excluding the determined channel when the determined channel is being used by the respective one of the plurality of sources to which the determined channel has already been assigned.

18. The communication method of claim 15, further comprising transmitting control information to a target in a power cell that is configured to receive wireless power via the determined channel when the determined channel is not being used by the respective one of the plurality of sources to which the determined channel has already been assigned.

19. The communication method of claim 18, further comprising:
performing communication with the target via the determined channel; and
detecting a number of sources attempting to use the determined channel and a channel frequency of the determined channel during a predetermined time period after the communication with the target has been completed.
